(19) United States
(12) Patent Application Publication
(10) Pub. No.: US 2014/0165576 A1
(43) Pub. Date: Jun. 19, 2014

(54) ACTIVE CONTROL FUEL NOZZLE SYSTEM

(71) Applicant: GENERAL ELECTRIC COMPANY, Schenectady, NY (US)

(72) Inventors: Wei CHEN, Greenville, SC (US); Keith McManus, Clifton Park, NY (US); John Lipinski, Greenville, SC (US); Carolyn Antoniono, Greenville, SC (US)

(73) Assignee: General Electric Company, Schenectady, NY (US)

(21) Appl. No.: 13/714,113

(22) Filed: Dec. 13, 2012

(51) Int. Cl. F02C 9/26

(52) U.S. Cl. CPC F02C 9/26
USPC 60/772; 60/734

(57) ABSTRACT

It is desirable for a gas turbine system to operate in a wide range operating conditions. However, under certain conditions there exist dynamic boundaries that limit a combustor from reaching its designated condition. Perturbation devices formed of electromagnetic plates can be incorporated into fuel nozzles of the combustor to influence the dynamics so that the range of operating conditions can be widened. The perturbation devices vibrate according to the perturbation signals provided from a dynamics controller. The vibration characteristics of the perturbation devices can be controlled by controlling the attributes of the perturbation signals. The vibrations influence the dynamics of fluid—fuel, oxidant, or both—flowing past the perturbation devices within the fuel nozzles.

One or more aspects of the present invention relate to method, apparatus and system for controlling combustion dynamics in a gas turbine combustor. In particular, one or more aspects relate to active control of fuel nozzle system to improve the combustion dynamics during combustion operation.

### BACKGROUND OF THE INVENTION

It is desirable for a gas turbine combustor to operate in a wide range operating conditions. However, under certain conditions there exist dynamic boundaries that limit a combustor from reaching its designated condition. Combustor dynamics refer to the pressure oscillations and/or pulsations that occur during combustion. These dynamics can become destructive to the gas turbine itself, for example, at resonant frequencies. Also, undesirable effects such as increase emission of NOx can occur.

It would be desirable to utilize influence the combustion dynamics to mitigate harmful effects.

### BRIEF SUMMARY OF THE INVENTION

An aspect of the present invention relates to a perturbation device for use in a fuel nozzle of a combustor of a gas turbine system. The perturbation device can comprise a plurality of flexible plates including first and second flexible plates. Both the first and second flexible plates may be electromagnetic plates and respectively structured to receive first and second perturbation signals and generate corresponding first and second magnetic fluxes. The first and second flexible plates may be physically disposed relative to each other such that one or both of the first and second flexible plates vibrate due to an interaction between the first and second magnetic fluxes. The first flexible plate may be structured to receive an AC signal as the first perturbation signal and generate a corresponding AC magnetic flux as the first magnetic flux.

Another aspect of the present invention relates to a control system for influencing dynamics in a combustor of a gas turbine system. The control system can comprise a plurality of perturbation devices for a plurality of fuel nozzles of the combustor, one or more pressure sensors, and a dynamics controller. Each fuel nozzle may be structured to deliver fluid to a combustion chamber of the combustor. The fluid can include fuel, oxidant, or mixture of fuel and oxidant. The one or more pressure sensors may be structured to measure pressure in the combustion chamber. The dynamics controller may be structured to analyze pressure dynamics based on the pressure measured by the one or more pressure sensors, and to output a plurality of perturbation signals to control the plurality of perturbation devices based on the analyzed pressure dynamics. The plurality of perturbation signals may include first and second perturbation signals, in which the first perturbation signal may be an AC signal. The plurality of perturbation devices may include a first perturbation device and the plurality of fuel nozzles may include a first fuel nozzle, in which the first perturbation device may be physically disposed within the first fuel nozzle upstream of the combustion chamber such that the fluid flows past the first perturbation device. The first perturbation device may comprise a plurality of flexible plates including first and second flexible plates, in which both may be electromagnetic plates. The first and second flexible plates may be physically disposed relative to each other such that one or both of the first and second flexible plates vibrate due to an interaction between the first and second magnetic fluxes. The dynamics controller may be structured to output the first and second perturbation signals to control vibration characteristics of the first flexible plate, the second flexible plate, or both based on the pressure dynamics.

Another aspect of the present invention relates to a method for influencing dynamics in a combustor of a gas turbine system. The method may be relevant for a combustor that comprises a combustion chamber, a plurality of fuel nozzles including a first fuel nozzle, and a plurality of perturbation devices including a first perturbation device. Each of the plurality of fuel nozzles, including the first fuel nozzle, may be structured to deliver fluid to the combustion chamber. The fluid, being in a gas form preferably, can include fuel, oxidant, or mixture of fuel and oxidant. The first perturbation device may be physically disposed within the first fuel nozzle upstream of combustion chamber such that the fluid flows past the first perturbation device. The first perturbation device may comprise a plurality of flexible plates including first-first and first-second flexible plates, both of which may be electromagnetic plates. The first-first and first-second flexible plates may be respectively structured to receive the first-first and first-second perturbation signals and generate corresponding first-first and first-second magnetic fluxes. The first-first and first-second flexible plates may be physically disposed relative to each other such that one or both of the first-first and first-second flexible plates vibrate due to an interaction between the first-first and first-second magnetic fluxes. The method to influence the dynamics in such a combustor may comprise the steps of analyzing pressure dynamics based on measurements provided from one or more pressure sensors measuring pressure in the combustion chamber, and controlling attributes of the first-first and first-second perturbation signals provided to the first-first and first-second flexible plates to control vibration characteristics of the first perturbation device based on the analyzed pressure dynamics, in which the first perturbation may be AC signal.

The invention will now be described in greater detail in connection with the drawings identified below.

### BRIEF DESCRIPTION OF THE DRAWINGS

These and other features of the present invention will be better understood through the following detailed description of example embodiments in conjunction with the accompanying drawings, in which:

FIG. 1 illustrates a block diagram of an example gas turbine system according to an aspect of the present invention;

FIG. 2 illustrates an example of a combustor according to an aspect of the present invention;

FIG. 3 illustrates an example of a fuel nozzle with perturbation devices according to an aspect of the present invention;

FIG. 4 illustrates an example of a perturbation device according to an aspect of the present invention;

FIG. 5 illustrates a diagram of a control system to influence dynamics of a gas turbine system according to an aspect of the present invention;

FIG. 6 illustrates a flow chart of an example method to influence dynamics of a gas turbine system according to an aspect of the present invention; and

FIG. 7 illustrates a flow chart of an example process to control perturbation signals provided to perturbation devices according to an aspect of the present invention.

### DETAILED DESCRIPTION OF THE INVENTION

Novel method, system, and apparatus for actively controlling the combustor dynamics are described. In one aspect, the described method, system, and apparatus relate to actively controlling the combustion dynamics through using perturbation devices disposed in one or more fuel nozzles in which premixed fuel and oxidant (e.g., air) flow. Operating characteristics of the perturbation devices—frequencies, magnitudes (or amplitudes) and phases—may be controlled. Preferably, the operating characteristics of at least one perturbation device are controlled separately from all other perturbation devices. Most preferably, the operating characteristics of all perturbation devices are individually controlled.

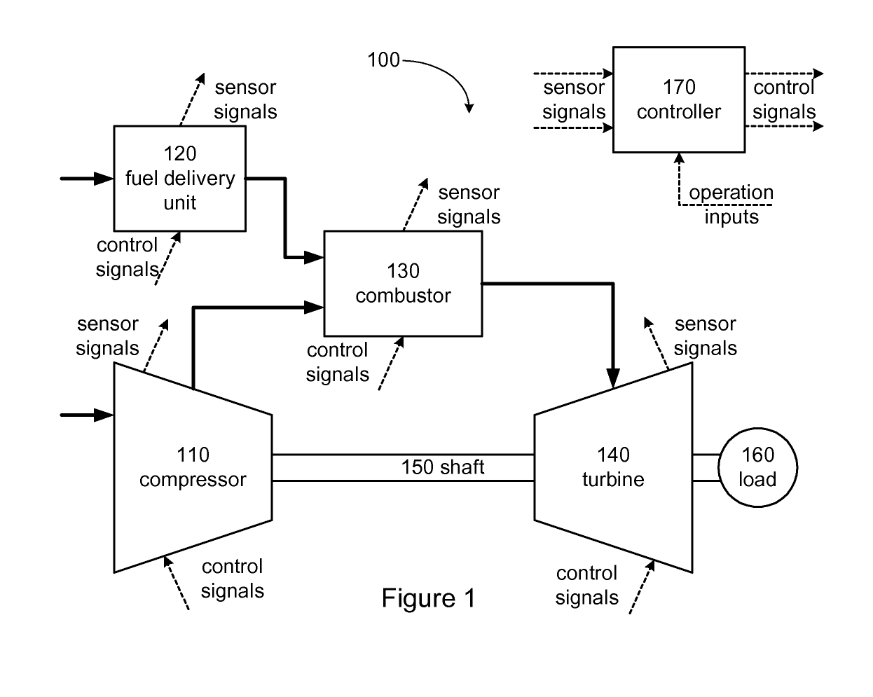

FIG. 1 illustrates an example of a gas turbine system 100. As seen, the gas turbine system 100 may include a combustor 130 that generates high energy gases to drive a gas turbine 140 which can be used to drive a load 160 to perform useful work such as generating electricity. The turbine 140 may also include a shaft 150 operatively coupled to a compressor 110, which compresses and provides compressed fluid containing oxidant, e.g., air, to the combustor 130. The gas turbine system 100 may further include a fuel delivery unit 120 which delivers fuel to the combustor 130.

The gas turbine system 100 may include a system controller 170 that is structured to control the operation of the gas turbine system 100. As seen, the system controller 170 may as inputs one or more sensor signals from sensors monitoring the system units (compressor 110, fuel delivery unit 120, combustor 130, and turbine 140). While not shown, sensors can also be provided to monitor the load 160 and the shaft 150. The system controller 170 can also receive operation inputs such as an instruction from an operator to start up, partial load operation, full load operation, shut down, and so on. Based on the received inputs, the system controller 170 may output control signals to the system units to control the system operation. The sensor signals from the system units 110, 120, 130 and 140 to the system controller 170 and the control signals from the system controller 170 to the units 110, 120, 130 and 140 are represented as dashed arrows. To minimize clutter in FIG. 1, the connections between system units 110, 120, 130 and 140 and the system controller 170 are omitted.

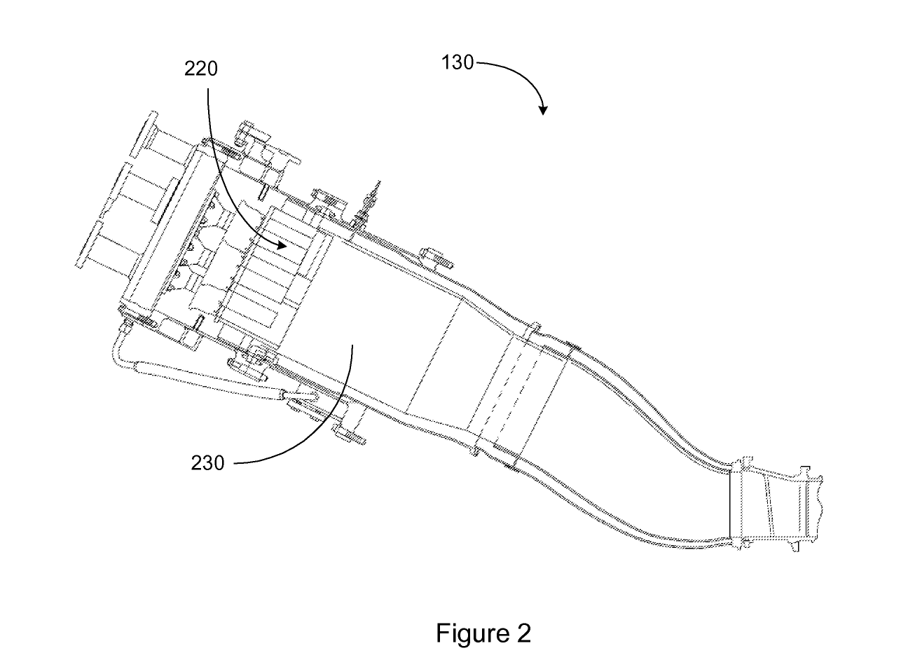

FIG. 2 illustrates an example combustor 130, which may include a plurality of fuel nozzles 220, each of which may be structured to deliver fluid to the combustion chamber 230. The fluid delivered by each fuel nozzle 220 may include fuel from the fuel delivery unit 120, compressed oxidant such as air from the compressor 110, or a mixture of fuel and oxidant. The fluid may be delivered in a gas form. The fuel/oxidant mixture is combusted within the combustion chamber 230, and the resulting high energy gas to the turbine 140.

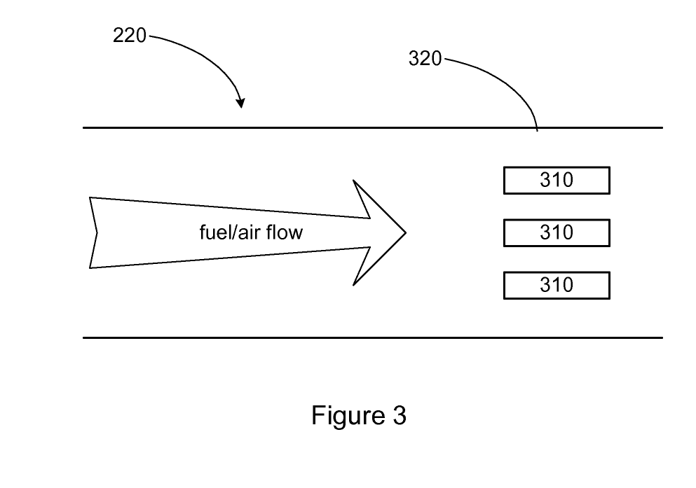

FIG. 3 illustrates an example fuel nozzle 220. As seen, the fuel nozzle 220 may include one or more perturbation devices 310. Preferably, perturbation devices 310 are disposed within the fuel nozzle 220 upstream of the combustion chamber 230 such that the fluid flows past the perturbation devices 310. As an example, the perturbation devices 310 may be disposed at or in proximity to an end of the fuel nozzle 220 facing the combustion chamber 230. In FIG. 3, the perturbation devices 310 are all illustrated to be disposed in a same longitudinal—along the direction of the fuel/oxidant/mixture flow—location within the fuel nozzle 200. However, this is not a limitation. When there are multiple perturbation devices 310 within a particular fuel nozzle 220, the locations of the perturbation devices 310 need not be the same between any two perturbation devices 310. One or more perturbation devices can be attached to an inner surface 320 of the fuel nozzle 200.

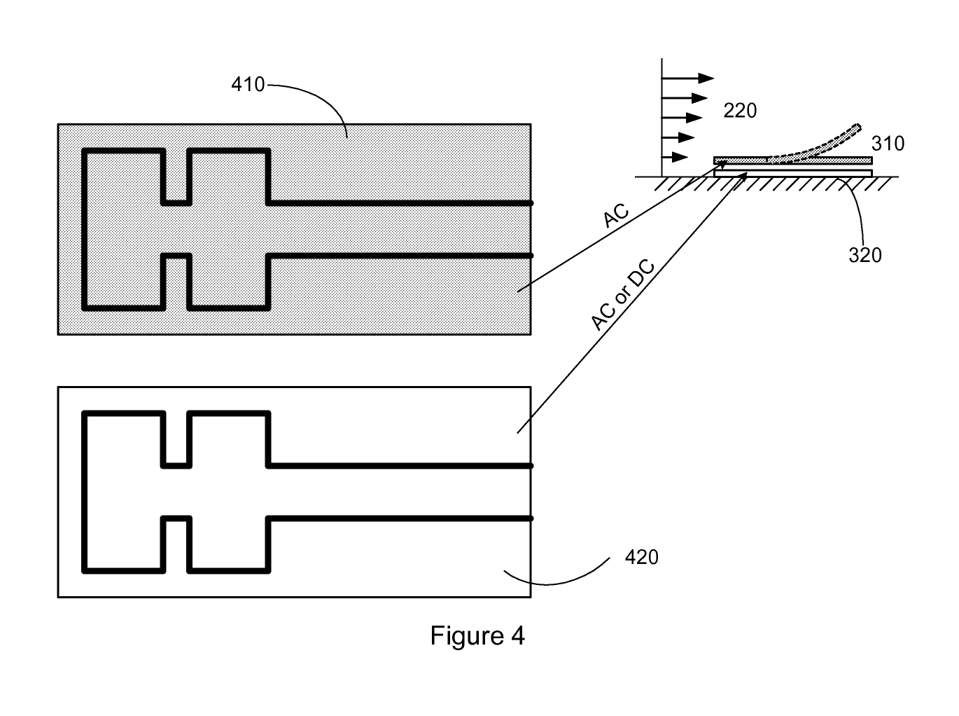

FIG. 4 illustrates an example perturbation device 310. The example perturbation device 220 may be a micro-electro-mechanical system (MEMS) device. As seen, the perturbation device 310 may include a plurality of flexible plates. For simplicity of explanation, only two flexible plates—first and second flexible plates 410, 420—are illustrated. However, the number of flexible plates can be two or any number greater than two. In this figure, it is assumed that both the first and second flexible plates 410, 420 are electromagnetic plates. As an example, one or both electromagnetic plates can be made from thin flexible alloys and painted with high temperature ceramic which insulates the electric circuit from conducting metal. The first flexible plate 410 may receive a first perturbation signal and generate a first magnetic flux corresponding to the received first perturbation signal. Similarly, the second flexible plate 420 may receive a second perturbation signal and correspondingly generate a second magnetic flux.

Note that when two magnetic fluxes interact, physical forces may be exerted on the flexible plates. Thus, in one aspect, the first and second flexible plates 410, 420 may be physically disposed relative to each other such that one or both of the first and second flexible plates 410, 420 vibrate due to the interaction between the first and second magnetic fluxes. For example, the first flexible plate 410 may be disposed in close proximity to the second flexible plate 420 so as to vibrate with respect to the second flexible plate 420 as indicated by the dashed lines in FIG. 4.

In the upper right portion of this figure, the second flexible plate 420 is shown to be fixedly attached to an inner surface 320 of the fuel nozzle 220. That is, only the first flexible plate 410 is shown to vibrate. However, this is not a limitation. In one alternative, the first flexible plate 410 may be fixed and the second flexible plate 420 may vibrate. In another alternative, both flexible plates 410, 420 may vibrate. Generally, of the plurality of flexible plates of a particular perturbation device 310, at least one can be structured to vibrate.

Also in the upper right portion, arrows indicate an example flow gradient of the fluid flowing within the fuel nozzle 220. The vibrations can affect the gaseous fluid flowing past the perturbation device 310. Then if the vibration characteristics of one or both of the first and second flexible plates 410, 420 can be controlled, the dynamics that occur within the combustor 130, and in particular the dynamics occurring within the combustion chamber 230, can be influenced.

It is preferred that at least one flexible plate of the perturbation device 310 receives an AC signal as its perturbation signal. In FIG. 4, it is assumed that the first flexible plate 410 receives the AC signal as the first perturbation signal, and generates a corresponding AC magnetic flux as the first magnetic flux. Note that the characteristics of the first magnetic flux may significantly depend on the characteristics of the first perturbation signal including, among others, any one or more of an amplitude, frequency and phase.

In one aspect, the second flexible plate 420 can receive a DC signal as the second perturbation signal, and generate a corresponding DC flux as the second magnetic flux. Note that the characteristics of the second magnetic flux may significantly depend on the characteristics of the second perturbation signal including, among others, one or both of magnitude and polarity.

In another aspect, the second flexible plate 420 can also receive an AC signal as the second perturbation signal, and generate a corresponding AC flux as the second magnetic flux. For differentiation purposes, the AC signals received by the first and second flexible plates 410, 420 and the correspondingly generated magnetic fluxes will be referred to as first and second AC signals and first and second AC fluxes. The characteristics of the second AC flux may significantly depend on the characteristics of the second AC signal including, among others, any one or more of amplitude, frequency and phase.

As indicated above, one or both of the first and the second flexible plates 410, 420 can vibrate due to the interaction between the first and second magnetic fluxes. The vibration characteristics may depend on the characteristics of the first and second magnetic fluxes. For example, when the second perturbation signal is a DC signal, the vibration characteristics may largely depend on the characteristics of the AC and DC fluxes and the interaction therebetween. When the second perturbation signal is a second AC signal, the vibration characteristics may largely depend on the characteristics of the first and second AC fluxes and the interaction therebetween.

Note that the type of the perturbation signal a particular flexible plate receives need not bear any correlation with whether that particular flexible plate vibrates. For example, even though the first flexible plate 410 receives an AC signal as the first perturbation signal, the first flexible plate 410 can vibrate or be fixed. As another example, regardless of whether the second flexible plate 420 receives an AC or a DC signal as the second perturbation signal, the second flexible plate 420 can vibrate or be fixed. It is only necessary that among the plurality of flexible plates of the perturbation device 310, at least one flexible plate vibrates.

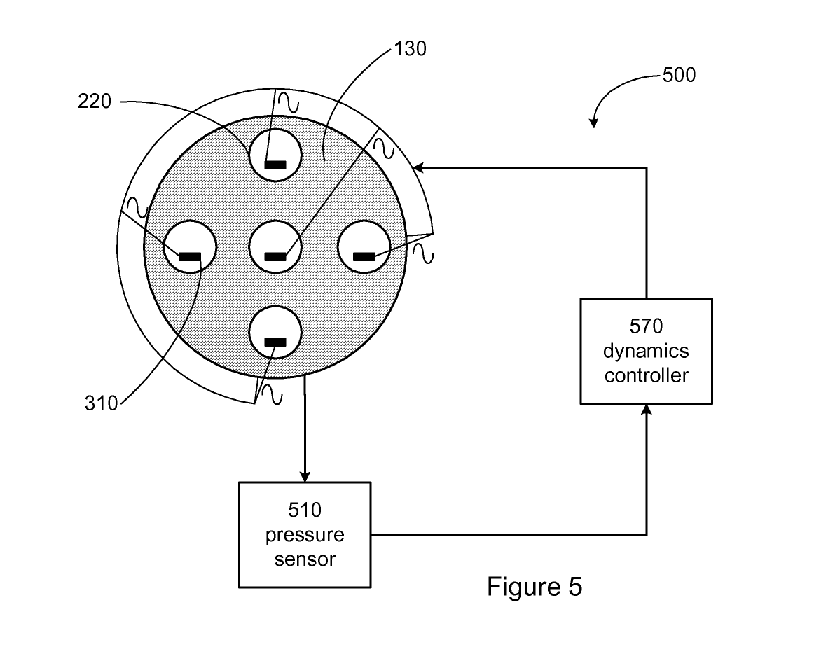

FIG. 5 illustrates a diagram of a control system 500 to influence the dynamics in a combustor 130. From one perspective, the control system 500 may be viewed as being part of the gas turbine system 100. As seen, the combustor 130 of the control system 500 may include a plurality of perturbation devices 310 for a plurality of fuel nozzles 220. As indicated above, each fuel nozzle 220 may deliver fluid to the combustion chamber 230 of the combustor. The gaseous fluid delivered by each fuel nozzle 220 may include fuel, oxidant, or a mixture thereof. For simplicity, only the fuel nozzles 220 with at least one perturbation device 310 are illustrated. It should be noted however that the combustor 130 may include fuel nozzles that do not have any perturbation devices 310.

The control system 500 may also include one or more pressure sensors 510 structured to measure pressure in the combustor 130, and particularly within the combustion chamber 230. The control system 500 may further include a dynamics controller 570 to control the operation of influencing the dynamics of the combustor. The dynamics controller 570 in FIG. 5 may be the same or a part of the system controller 170 in FIG. 1, or may be different altogether.

The dynamics controller 570 may analyze the pressure dynamics based on the pressure measured by the one or more pressure sensors 510. In this way, the pressure sensors 510 feedback to the dynamics controller 570. Based on the analysis, the dynamics controller 570 may output a plurality of perturbation signals to control the plurality of perturbation devices 310. It can be assumed that first and second perturbation signals are included among the perturbation signals output by the dynamics controller 570.

In FIG. 5, at least one fuel nozzle 220 includes at least one perturbation device 310. For purposes of discussion, the one fuel nozzle 220 will be referred to as a first fuel nozzle 220 and the one perturbation device 310 will be referred to as a first perturbation device 310. Then it can be said that the first perturbation device 310 is physically disposed within the first fuel nozzle 220 upstream of the combustion chamber 230 such that the fluid flows past the first perturbation device 310 within the first fuel nozzle 220.

The first perturbation device 310 may comprise a plurality of flexible plates. For discussion purposes, it is assumed that the first perturbation device 310 includes at least the first and second flexible plates 410, 420 as described with respect to FIG. 4. That is, it is assumed that the first and second flexible plates 410, 420 of the first perturbation device 310 are electromagnetic plates that generate magnetic fluxes corresponding to the received perturbation signals, and that the first and second flexible plates 410, 420 are physically disposed relative to each other such that one or both of the flexible plates 410, 420 vibrate due to an interaction between their respective magnetic fluxes. It is also assumed that the first and second flexible plates 410, 420 respectively receive the first and second perturbation signals from the dynamics controller 570. It can then be said that the dynamics controller 570 is structured to output the first and second perturbation signals based on the pressure dynamics. The first and second perturbation signals can be output to control the vibration characteristics of one or both of the first and second flexible plates 410, 420 of the first perturbation device 310. It is further assumed that the dynamics controller 570 outputs an AC signal as the first perturbation signal.

Recall from above discussion that the vibration generated due to interactions between any two flexible plates can influence the dynamics of the combustor. Also recall that the vibration characteristics can largely depend on the magnetic fluxes generated by the flexible plates. The magnetic fluxes in turn are generated in accordance with the perturbation signals received by the flexible plates.

Then between the first and second first and second flexible plates 410, 420 of the first perturbation device 310, the dynamics controller 570 can control the vibration characteristics of the first second flexible plate 410, of the second flexible plate 420, or of both plates by controlling the characteristics of the first and second perturbation signals provided to the first and second flexible plates 420. In this way, the dynamics controller 570 may influence the dynamics that occur within the combustor 130. The degree of influence can increase as more and more perturbation devices 310—of the same fuel nozzle 220 and/or of different fuel nozzles 220—are controlled through controlling the plurality of perturbation signals.

In one aspect, one of the first and second flexible plates 410, 420 may be stationary relative to the first fuel nozzle 220. For example, one of the flexible plates may be fixedly attached to the inner surface 320 of the first fuel nozzle 220. In this instance, the other flexible plate may vibrate, and the dynamics controller 570 may output first and second perturbation signals to control the vibration characteristics of the vibrating flexible plate. As another example, both of the flexible plates may vibrate. In this instance, the dynamics controller 570 may output first and second perturbation signals to control the vibration characteristics of both vibrating flexible plates.

As indicated above, preferably the dynamics controller 570 outputs a first AC signal as the first perturbation signal. The dynamics controller 570 may output either a second AC or a DC signal as the second perturbation signal. In one aspect, the dynamics controller 570 may switch from outputting one of AC and DC signal to outputting the other from time to time. That is, the type of signal is not necessarily fixed for the second perturbation signal.

It is also indicated above that the pressure sensors 510 provide feedback to the dynamics controller 570. Thus, in an aspect, the dynamics controller 570 may continually analyze the pressure dynamics based on the pressure information from the pressure sensors 510 and adjust the characteristics of the first and second perturbation signals. That is, the dynamics controller 570 may adjust any one or more of the amplitude, frequency and phase of the first perturbation signal based on the pressure dynamics. If the second perturbation signal is a DC signal, the dynamics controller 570 may adjust any one or both of the magnitude and polarity of the second perturbation signal based on the pressure dynamics. If the second perturbation signal is the second AC signal, the dynamics controller 570 may adjust any one or more of the amplitude, frequency and phase of the second perturbation signal based on the pressure dynamics.

It should be noted that all perturbation devices 310 need not be controlled in a same manner. In other words, between at least two perturbation devices 310, the perturbation signals can be independently provided to the two perturbation devices 310. Referring back to FIG. 5, assumed that in addition to the first perturbation devices 310, there is also a second perturbation devices 310 disposed within a second fuel nozzle 220 upstream of the combustion chamber 230 such that the fluid flows past the second perturbation device 310. Also assume that the second perturbation devices 310 includes at least third and fourth flexible plates 410, 420, both of which are electromagnetic plates and generate third and fourth magnetic fluxes corresponding to the received perturbation signals. Further assume that the dynamics controller 570 can output third and fourth perturbation signals to the third and fourth flexible plates 410, 420, in which the third perturbation signal is an AC signal. In one aspect, the dynamics controller 570 may output the third and fourth perturbation signals independent from the first and second perturbation signals. In other words, there is no requirement that common signals be provided to the first and second perturbation devices 310.

Then based on the feedback pressure dynamics, the dynamics controller 570 may adjust any one or more of an amplitude, a frequency and a phase of the third perturbation signal. Also, if the fourth perturbation signal is a DC signal, the dynamics controller 570 may adjust any one or more of the magnitude and polarity of the fourth perturbation signal based on the pressure dynamics. If the fourth perturbation signal is another AC signal, the dynamics controller 570 may adjust any one or more of the amplitude, frequency and phase of the fourth perturbation signal based on the pressure dynamics.

Note that even when the first and second perturbation devices 310 are disposed within the same fuel nozzle 220, the perturbation signals provided to the two perturbation devices 310 may still be independently provided.

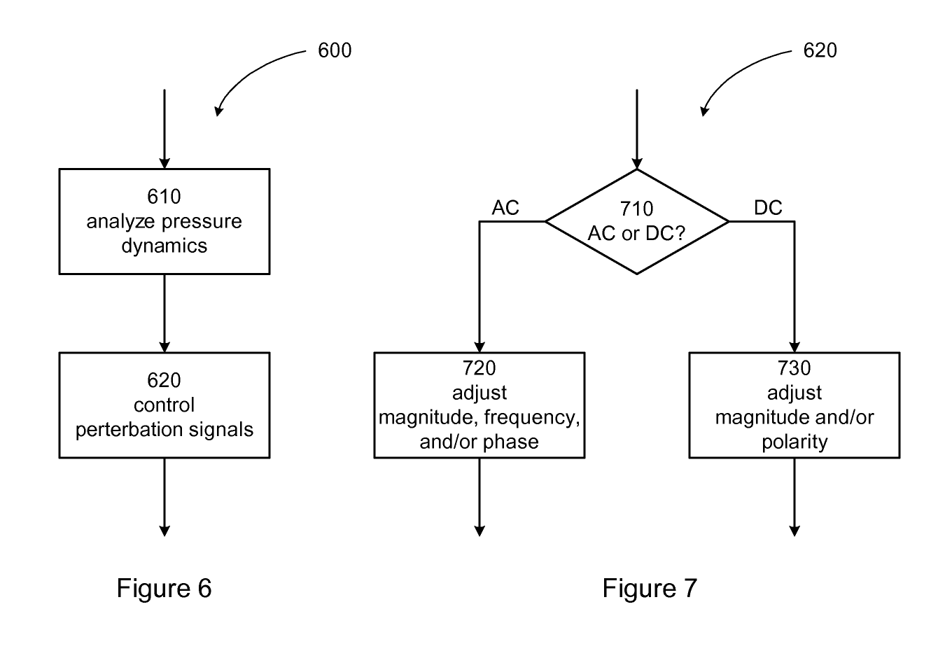

FIG. 6 illustrates a flow chart of an example method 600 to influence combustor dynamics. For discussion purposes, the gas turbine system 100 is assumed. The method 600 may be performed by the dynamics controller 570. In step 610, the pressure dynamics may be analyzed based on measurements provided from one or more pressure sensors that measure pressure in the combustion chamber 230. Then in step 620, based on the analyzed pressure dynamics, the attributes of the first and second perturbation signals provided to the first and second flexible plates (410, 420) may be controlled to control the vibration characteristics of the first perturbation device. The first perturbation signal is preferably an AC signal.

FIG. 7 illustrates a flow chart of an example process to implement step 620. In step 710, it is determined whether a perturbation signal from the dynamics controller 570 is an AC or a DC signal. If the perturbation signal is an AC signal, then in step 720, any one or more of the amplitude, frequency, and phase of the perturbation signal may be adjusted based on the analyzed pressure dynamics. If the perturbation signal is a DC signal, then in step 730, any one or more of the magnitude and polarity of the perturbation signal may be adjusted based on the analyzed pressure dynamics. For example, since the first perturbation signal is an AC signal, the amplitude, frequency, and phase of the first perturbation signal may be adjusted. If the second perturbation signal is also an AC signal, then the amplitude, frequency, and phase of the second perturbation signal may be adjusted. If the second perturbation signal is a DC signal, then the magnitude and polarity thereof may be adjusted.

When there are multiple perturbation devices 310, the perturbation signals applied to each of the perturbation devices 310 may be controlled as well. That is, in step 620, the third and fourth perturbation signals provided to the third and fourth flexible plates 410, 420 may be controlled based on the analyzed pressure dynamics to control the vibration characteristics of the second perturbation device 310. In this instance, the third perturbation signal may be an AC signal, and thus, in steps 710 and 720, any one or more of the amplitude, frequency and phase of the third perturbation signal may be adjusted. If the fourth perturbation signal is an AC signal, then the amplitude, frequency, and phase of the fourth perturbation signal may be adjusted. Otherwise, the magnitude and polarity of the fourth perturbation signal may be adjusted.

There are significant flexibilities and benefits afforded by the disclose aspects. A non-exhaustive list of the flexibilities include:
Multiple perturbation devices may be installed in a single fuel nozzle;
Each perturbation device can operate at different frequencies and magnitudes;
Within one fuel nozzle, several frequencies, amplitudes, and/or phase angles can be applied to achieve maximum benefits; and
Different fuel nozzles may operate their own perturbation devices in different operation modes to achieve maximum benefits.

A non-exhaustive list of benefits include:
eliminate dynamic walls in an operating window;
produce low turn downs;
enhance combustion;
reduce emissions;
mitigate variances caused by manufacturing tolerances; and
produce robust combustion flames.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A perturbation device for use in a fuel nozzle of a combustor of a gas turbine system, the perturbation device comprising:
a plurality of flexible plates including first and second flexible plates, both the first and second flexible plates being electromagnetic plates,
wherein the first and second flexible plates are respectively structured to receive first and second perturbation signals and generate corresponding first and second magnetic fluxes,
wherein the first and second flexible plates are physically disposed relative to each other such that one or both of the first and second flexible plates vibrate due to an interaction between the first and second magnetic fluxes, and
wherein the first flexible plate is structured to receive an AC signal as the first perturbation signal and generate a corresponding AC magnetic flux as the first magnetic flux.

2. The perturbation device of claim 1, wherein one of the first and second flexible plates is structured to be stationary and the other of the first and second flexible plates is structured to vibrate due to the interaction between the first and second magnetic fluxes.

3. The perturbation device of claim 1, wherein the second flexible plate is structured to receive a DC signal as the second perturbation signal and generate a corresponding DC flux as the second magnetic flux.

4. The perturbation device of claim 1,
wherein the AC signal received by the first flexible plate is a first AC signal, and
wherein the second flexible plate is structured to receive a second AC signal as the second perturbation signal and generate a corresponding AC flux as the second magnetic flux.

5. The perturbation device of claim 1, wherein the perturbation device is a micro-electro-mechanical system (MEMS) device.

6. A control system for influencing dynamics in a combustor of a gas turbine system, the control system comprising:
a plurality of perturbation devices for a plurality of fuel nozzles of the combustor, each fuel nozzle being structured to deliver fluid to a combustion chamber of the combustor, the fluid comprising fuel, oxidant, or a mixture of fuel and oxidant, the fluid being in a gas form;
one or more pressure sensors structured to measure pressure in the combustion chamber; and
a dynamics controller structured to analyze pressure dynamics based on the pressure measured by the one or more pressure sensors, and structured to output a plurality of perturbation signals to control the plurality of perturbation devices based on the analyzed pressure dynamics,
wherein the plurality of perturbation signals include first and second perturbation signals, the first perturbation signal being an AC signal,
wherein the plurality of perturbation devices include a first perturbation device and the plurality of fuel nozzles include a first fuel nozzle, the first perturbation device being physically disposed within the first fuel nozzle upstream of the combustion chamber such that the fluid flows past the first perturbation device,
wherein the first perturbation device comprises a plurality of flexible plates including first and second flexible plates, both the first and second flexible plates being electromagnetic plates,
wherein the first and second flexible plates are respectively structured to receive the first and second perturbation signals and generate corresponding first and second magnetic fluxes,
wherein the first and second flexible plates are physically disposed relative to each other such that one or both of the first and second flexible plates vibrate due to an interaction between the first and second magnetic fluxes,
wherein the dynamics controller is structured to output the first and second perturbation signals to control vibration characteristics of the first flexible plate, the second flexible plate, or both based on the pressure dynamics.

7. The control system of claim 6, wherein one of the first and second flexible plates is structured to be stationary relative to the first fuel nozzle and the other of the first and second flexible plates is structured to vibrate due to the interaction between the first and second magnetic fluxes.

8. The control system of claim 7, wherein the stationary flexible plate is fixedly attached to an inner surface of the first fuel nozzle.

9. The control system of claim 6, wherein the dynamics controller is structured to output a DC signal as the second perturbation signal such that the second flexible plate generates a corresponding DC flux as the second magnetic flux.

10. The control system of claim 9, wherein the dynamics controller is structured to adjust, based on the pressure dynamics,
any one or more of an amplitude, a frequency and a phase of the first perturbation signal, and
any one or more of a magnitude and a polarity of the second perturbation signal.

11. The control system of claim 6,
wherein the AC signal output by the dynamics controller a first AC signal, and
wherein the dynamics controller is structured to output a second AC signal as the second perturbation signal such that the second flexible plate generates a corresponding AC flux as the second magnetic flux.

12. The control system of claim 11, wherein the dynamics controller is structured to adjust, based on the pressure dynamics,
any one or more of an amplitude, a frequency and a phase of the first perturbation signal, and
any one or more of an amplitude, a frequency and a phase of the second perturbation signal.

13. The control system of claim 6,
wherein the plurality of perturbation signals include third and fourth perturbation signals, the third perturbation signal being an AC signal,
the plurality of perturbation devices include a second perturbation device and the plurality of fuel nozzles include a second fuel nozzle, the second perturbation device being physically disposed within the second fuel nozzle upstream of the combustion chamber such that the fluid flows past the second perturbation device,
wherein the second perturbation device comprises a plurality of flexible plates including third and fourth flexible plates, both the third and fourth flexible plates being electromagnetic plates,
wherein the third and fourth flexible plates are respectively structured to receive the third and fourth perturbation signals and generate corresponding third and fourth magnetic fluxes,
wherein the third and fourth flexible plates are physically disposed relative to each other such that one or both of the third and fourth flexible plates vibrate due to an interaction between the third and fourth magnetic fluxes,
wherein the dynamics controller is structured to output the third and fourth perturbation signals to control vibration characteristics of the third flexible plate, the fourth flexible plate, or both based on the pressure dynamics, and
wherein the dynamics controller is structured to output the first and second perturbation signals independent of the third and fourth perturbation signals.

14. The control system of claim 13, wherein the dynamics controller is structured to adjust, based on the pressure dynamics,
any one or more of an amplitude, a frequency and a phase of the first perturbation signal, and
any one or more of an amplitude, a frequency and a phase of the third perturbation signal.

15. The control system of claim 14, wherein the dynamics controller is structured to adjust, based on the pressure dynamics,
any one or more of an amplitude, a frequency and a phase of the second perturbation signal when the second perturbation signal is an AC signal,
any one or more of a magnitude and a polarity of the second perturbation signal when the second perturbation signal is a DC signal,
any one or more of an amplitude, a frequency and a phase of the fourth perturbation signal when the fourth perturbation signal is an AC signal, and
any one or more of a magnitude and a polarity of the fourth perturbation signal when the fourth perturbation signal is a DC signal.

16. A method for influencing dynamics in a combustor of a gas turbine system,
wherein the combustor comprises:
a combustion chamber,
a plurality of fuel nozzles, including a first fuel nozzle, each fuel nozzle being structured to deliver fluid to the combustion chamber, the fluid including fuel, oxidant, or a mixture of fuel and oxidant, the fluid being in a gas form, and
a plurality of perturbation devices including a first perturbation device physically disposed within the first fuel nozzle upstream of combustion chamber such that the fluid flows past the first perturbation device,
wherein the first perturbation device comprises a plurality of flexible plates including first and second flexible plates, both the first and second flexible plates being electromagnetic plates, the first and second flexible plates being respectively structured to receive the first and second perturbation signals and generate corresponding first and second magnetic fluxes, and the first and second flexible plates being physically disposed relative to each other such that one or both of the first and second flexible plates vibrate due to an interaction between the first and second magnetic fluxes, and
wherein the method comprises:
analyzing pressure dynamics based on measurements provided from one or more pressure sensors measuring pressure in the combustion chamber; and
controlling attributes of the first and second perturbation signals provided to the first and second flexible plates to control vibration characteristics of the first perturbation device based on the analyzed pressure dynamics, the first perturbation signal being an AC signal.

17. The method of claim 16, wherein the step of controlling the attributes of the first and second perturbation signals comprises:
adjusting, based on the analyzed pressure dynamics, any one or more of an amplitude, a frequency and a phase of the first perturbation signal;
adjusting, based on the analyzed pressure dynamics, any one or more of an amplitude, a frequency and a phase of the second perturbation signal when the second perturbation signal is an AC signal; and
adjusting, based on the analyzed pressure dynamics, any one or more of a magnitude and a polarity of the second perturbation signal when the second perturbation signal is a DC signal.

18. The control system of claim 16,
wherein the plurality of perturbation signals include third and fourth perturbation signals, the third perturbation signal being an AC signal,
the plurality of perturbation devices include a second perturbation device and the plurality of fuel nozzles include a second fuel nozzle, the second perturbation device being physically disposed within the second fuel nozzle upstream of the combustion chamber such that the fluid flows past the second perturbation device,
wherein the second perturbation device comprises a plurality of flexible plates including third and fourth flexible plates, both the third and fourth flexible plates being electromagnetic plates, the third and fourth flexible plates being respectively structured to receive the third and fourth perturbation signals and generate corresponding third and fourth magnetic fluxes, and the third and fourth flexible plates being physically disposed relative to each other such that one or both of the third and fourth plates vibrate due to an interaction between the third and fourth magnetic fluxes, and
wherein the method further comprises controlling attributes of the third and fourth perturbation signals provided to the third and fourth flexible plates to control vibration characteristics of the second perturbation device based on the analyzed pressure dynamics, the third perturbation signal being an AC signal.

19. The method of claim 18, wherein the step of controlling the attributes of the third and fourth perturbation signals comprises:
adjusting, based on the analyzed pressure dynamics, any one or more of an amplitude, a frequency and a phase of the third perturbation signal;
adjusting, based on the analyzed pressure dynamics, any one or more of an amplitude, a frequency and a phase of the fourth perturbation signal when the fourth perturbation signal is an AC signal; and
adjusting, based on the analyzed pressure dynamics, any one or more of a magnitude and a polarity of the fourth perturbation signal when the fourth perturbation signal is a DC signal.

20. The method of claim 18, wherein the first and second perturbation signals are controlled independent of the third and fourth perturbation signals.
